(19) United States
(12) Patent Application Publication
(10) Pub. No.: US 2024/0237757 A1
(43) Pub. Date: Jul. 18, 2024

(54) AEROSOL GENERATING APPARATUS AND METHOD OF CONTROLLING SAME

(71) Applicant: KT&G CORPORATION, Daejeon (KR)

(72) Inventors: Yong Hwan KIM, Gyeonggi-do (KR); Dong Sung KIM, Seoul (KR); Hun II LIM, Seoul (KR); Seok Su JANG, Daejeon (KR)

(73) Assignee: KT&G CORPORATION, Daejeon (KR)

(21) Appl. No.: 18/289,312

(22) PCT Filed: Feb. 10, 2023
(86) PCT No.: PCT/KR2023/001963

§ 371 Date: Nov. 2, 2023

(30) Foreign Application Priority Data
Feb. 11, 2022 (KR) 10-2022-0018327

(51) Int. Cl. A24F 40/57; A24F 40/20; A24F 40/465; A24F 40/51; A24F 40/53; A24F 40/60

(52) U.S. Cl. CPC A24F 40/57; A24F 40/51; A24F 40/53; A24F 40/20; A24F 40/465; A24F 40/60

(57) ABSTRACT

An aerosol-generating apparatus and a method of controlling the same are provided. The aerosol-generating apparatus includes a heater configured to heat at least a portion of an aerosol-generating article, a temperature sensor configured to measure a temperature of the heater, and a processor configured to control supply of power to the heater according to a first preheating profile defining a preset preheating time and a preset preheating temperature, wherein the processor is further configured to, when the temperature of the heater is higher than or equal to a reference temperature, control supply of power to the heater according to a second preheating profile that is different from the first preheating profile.

### TECHNICAL FIELD

One or more embodiments relate to an aerosol-generating apparatus and a method of controlling the same.

### BACKGROUND ART

Recently, demand for alternative methods to overcome the shortcomings of general cigarettes has increased. For example, there is increasing demand for a system of generating aerosol by heating cigarettes or an aerosol-generating material by using an aerosol-generating apparatus, rather than by burning cigarettes.

A target temperature may be set in the aerosol-generating apparatus to heat an aerosol-generating article. Before the aerosol-generating article is heated, the aerosol-generating apparatus may preheat a heater for a certain period of time, and thus the temperature of the heater may be increased to the target temperature.

### DISCLOSURE OF INVENTION

### Technical Problem

A condition under which a user uses an aerosol-generating apparatus may include, for example, smoking in a place with an exceedingly high or low ambient temperature, smoking in summer or winter, smoking indoors or outdoors, or smoking immediately after previously smoking.

In particular, when a user finishes an aerosol-generating article after the preset number of puffs, a heater of an aerosol-generating apparatus may already be heated to a high temperature when the user inserts a new aerosol-generating article into the aerosol-generating apparatus to continue smoking. In this case, the heater of the aerosol-generating apparatus may be preheated again at a high temperature. When the heater of the aerosol-generating apparatus is preheated according to the same temperature profile during initial smoking and continued smoking, aerosol having a high temperature may be generated from the aerosol-generating article during the continued smoking, which causes inconvenience to the user.

The technical problems of the disclosure are not limited to the aforementioned description and technical problems that are not stated may be clearly understood by one of ordinary skill in the art from the embodiments described hereinafter and the attached drawings.

### Solution to Problem

According to one or more embodiments, there is provided an aerosol-generating apparatus for distinguishing initial smoking from continued smoking and controlling a temperature of a heater according to preheating profiles respectively corresponding to the initial smoking and the continued smoking.

An aerosol-generating apparatus includes a heater configured to heat at least a portion of an aerosol-generating article, a temperature sensor configured to measure a temperature of the heater, and a processor configured to control supply of power to the heater according to a first preheating profile defining a preset preheating time and a preset preheating temperature, wherein the processor is further configured to, when the temperature of the heater is higher than or equal to a reference temperature, control the supply of power to the heater according to a second preheating profile that is different from the first preheating profile.

A method of controlling an aerosol-generating apparatus includes measuring a temperature of a heater configured to heat at least a portion of an aerosol-generating article, determining whether the temperature of the heater is higher than or equal to a reference temperature, and, when the temperature of the heater is higher than or equal to the reference temperature, controlling supply of power to the heater according to a second preheating profile that is different from a first preheating profile.

### Advantageous Effects of Invention

According to one or more embodiments, as a heater is preheated according to different preheating profiles respectively corresponding to initial smoking and continued smoking, the heat of aerosol generated from an aerosol-generating article may be reduced during the continued smoking, and user inconvenience resulting from aerosol having a high temperature may be prevented.

Also, according to one or more embodiments, when a preheating temperature profile corresponding to continued smoking is used, a temperature decrease period increases, the amount of current consumed by the heater during the continued smoking of the user may be reduced.

Effects of the embodiments are not limited to those stated above, and effects that are not described herein may be clearly understood by one of ordinary skill in the art from the present specification and the attached drawings.

### BRIEF DESCRIPTION OF DRAWINGS

FIGS. 1 to 3 respectively illustrate examples in which a cigarette is inserted into an aerosol-generating apparatus, according to an embodiment.

FIGS. 4 and 5 respectively illustrate examples of cigarettes according to an embodiment.

FIG. 6 is a schematic block diagram of an aerosol-generating apparatus according to an embodiment.

FIG. 7 is an example diagram for explaining a temperature profile in an entire heating section of an aerosol-generating apparatus.

FIG. 8 is an example diagram for explaining an example of a preheating section of the temperature profile of FIG. 7.

FIG. 9 is an example diagram for explaining another example of a preheating section of the temperature profile of FIG. 7.

FIG. 10 is a flowchart of a method of controlling an aerosol-generating apparatus, according to another embodiment.

FIG. 11 is a flowchart of a method of controlling an aerosol-generating apparatus, according to another embodiment.

FIG. 12 is a block diagram of an aerosol-generating apparatus according to another embodiment.

FIGS. 13 to 16 illustrate a preheating mode of the aerosol-generating apparatus of FIG. 12.

### MODE FOR THE INVENTION

With respect to the terms used to describe in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, a term which is not commonly used can be selected. In such a case, the meaning of the term will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

Hereinafter, the present disclosure will now be described more fully with reference to the accompanying drawings, in which exemplary embodiments of the present disclosure are shown such that one of ordinary skill in the art may easily work the present disclosure. The disclosure may, however, be embodied in many different forms and should not be construed as being limited to the embodiments set forth herein.

Hereinafter, embodiments of the present disclosure will be described in detail with reference to the drawings.

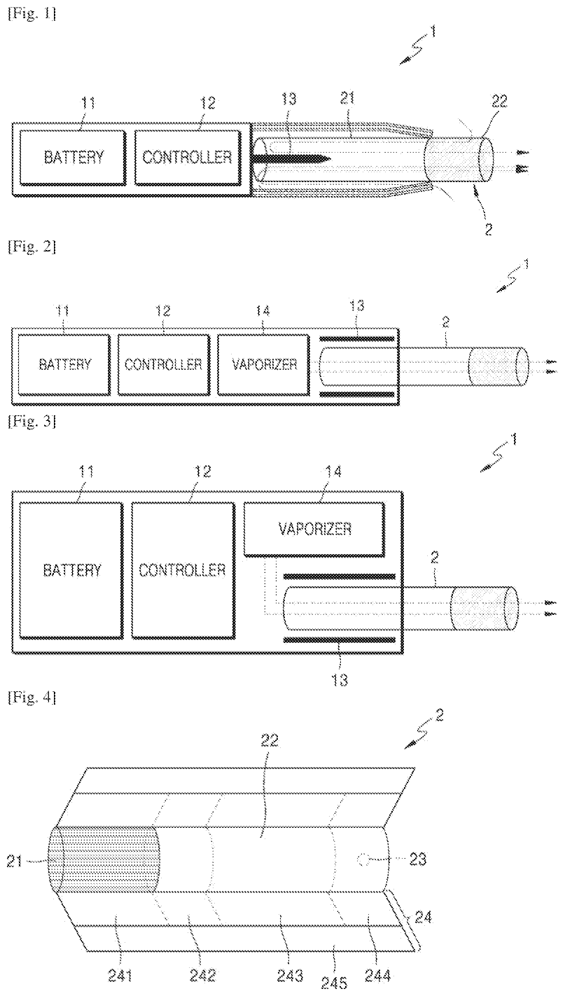

FIGS. 1 through 3 are diagrams showing examples in which a cigarette is inserted into an aerosol-generating device.

Referring to FIG. 1, the aerosol-generating device 1 may include a battery 11, a controller 12, and a heater 13. Referring to FIGS. 2 and 3, the aerosol-generating device 1 may further include a vaporizer 14. Also, the cigarette 2 may be inserted into an inner space of the aerosol-generating device 1.

FIGS. 1 through 3 illustrate components of the aerosol-generating device 1, which are related to the present embodiment. Therefore, it will be understood by one of ordinary skill in the art related to the present embodiment that other general-purpose components may be further included in the aerosol-generating device 1, in addition to the components illustrated in FIGS. 1 through 3.

Also, FIGS. 2 and 3 illustrate that the aerosol-generating device 1 includes the heater 13. However, as necessary, the heater 13 may be omitted.

FIG. 1 illustrates that the battery 11, the controller 12, and the heater 13 are arranged in series. Also, FIG. 2 illustrates that the battery 11, the controller 12, the vaporizer 14, and the heater 13 are arranged in series. Also, FIG. 3 illustrates that the vaporizer 14 and the heater 13 are arranged in parallel. However, the internal structure of the aerosol-generating device 1 is not limited to the structures illustrated in FIGS. 1 through 3. In other words, according to the design of the aerosol-generating device 1, the battery 11, the controller 12, the heater 13, and the vaporizer 14 may be differently arranged.

When the cigarette 2 is inserted into the aerosol-generating device 1, the aerosol-generating device 1 may operate the heater 13 and/or the vaporizer 14 to generate aerosol from the cigarette 2 and/or the vaporizer 14. The aerosol generated by the heater 13 and/or the vaporizer 14 is delivered to a user by passing through the cigarette 2.

As necessary, even when the cigarette 2 is not inserted into the aerosol-generating device 1, the aerosol-generating device 1 may heat the heater 13.

The battery 11 may supply power to be used for the aerosol-generating device 1 to operate. For example, the battery 11 may supply power to heat the heater 13 or the vaporizer 14, and may supply power for operating the controller 12. Also, the battery 11 may supply power for operations of a display, a sensor, a motor, etc. mounted in the aerosol-generating device 1.

The controller 12 may generally control operations of the aerosol-generating device 1. In detail, the controller 12 may control not only operations of the battery 11, the heater 13, and the vaporizer 14, but also operations of other components included in the aerosol-generating device 1. Also, the controller 12 may check a state of each of the components of the aerosol-generating device 1 to determine whether or not the aerosol-generating device 1 is able to operate.

The controller 12 may include at least one processor. A processor can be implemented as an array of a plurality of logic gates or can be implemented as a combination of a general-purpose microprocessor and a memory in which a program executable in the microprocessor is stored. It will be understood by one of ordinary skill in the art that the processor can be implemented in other forms of hardware.

The heater 13 may be heated by the power supplied from the battery 11. For example, when the cigarette is inserted into the aerosol-generating device 1, the heater 13 may be located outside the cigarette. Thus, the heated heater 13 may increase a temperature of an aerosol generating material in the cigarette.

The heater 13 may include an electro-resistive heater. For example, the heater 13 may include an electrically conductive track, and the heater 13 may be heated when currents flow through the electrically conductive track. However, the heater 13 is not limited to the example described above and may include all heaters which may be heated to a desired temperature. Here, the desired temperature may be preset in the aerosol-generating device 1 or may be set as a temperature desired by a user.

As another example, the heater 13 may include an induction heater. In detail, the heater 13 may include an electrically conductive coil for heating a cigarette in an induction heating method, and the cigarette may include a susceptor which may be heated by the induction heater.

For example, the heater 13 may include a tube-type heating element, a plate-type heating element, a needle-type heating element, or a rod-type heating element, and may heat the inside or the outside of the cigarette 2, according to the shape of the heating element.

Also, the aerosol-generating device 1 may include a plurality of heaters 13. Here, the plurality of heaters 13 may be inserted into the cigarette 2 or may be arranged outside the cigarette 2. Also, some of the plurality of heaters 13 may be inserted into the cigarette 2 and the others may be arranged outside the cigarette 2. In addition, the shape of the heater 13 is not limited to the shapes illustrated in FIGS. 1 through 3 and may include various shapes.

The vaporizer 14 may generate aerosol by heating a liquid composition and the generated aerosol may pass through the cigarette 2 to be delivered to a user. In other words, the aerosol generated via the vaporizer 14 may move along an air flow passage of the aerosol-generating device 1 and the air flow passage may be configured such that the aerosol generated via the vaporizer 14 passes through the cigarette to be delivered to the user.

For example, the vaporizer 14 may include a liquid storage, a liquid delivery element, and a heating element, but it is not limited thereto. For example, the liquid storage, the liquid delivery element, and the heating element may be included in the aerosol-generating device 1 as independent modules.

The liquid storage may store a liquid composition. For example, the liquid composition may be a liquid including a tobacco-containing material having a volatile tobacco flavor component, or a liquid including a non-tobacco material. The liquid storage may be formed to be detachable from the vaporizer 14 or may be formed integrally with the vaporizer 14.

For example, the liquid composition may include water, a solvent, ethanol, plant extract, spices, flavorings, or a vitamin mixture. The spices may include menthol, peppermint, spearmint oil, and various fruit-flavored ingredients, but are not limited thereto. The flavorings may include ingredients capable of providing various flavors or tastes to a user. Vitamin mixtures may be a mixture of at least one of vitamin A, vitamin B, vitamin C, and vitamin E, but are not limited thereto. Also, the liquid composition may include an aerosol forming substance, such as glycerin and propylene glycol.

The liquid delivery element may deliver the liquid composition of the liquid storage to the heating element. For example, the liquid delivery element may be a wick such as cotton fiber, ceramic fiber, glass fiber, or porous ceramic, but is not limited thereto.

The heating element is an element for heating the liquid composition delivered by the liquid delivery element. For example, the heating element may be a metal heating wire, a metal hot plate, a ceramic heater, or the like, but is not limited thereto. In addition, the heating element may include a conductive filament such as nichrome wire and may be positioned as being wound around the liquid delivery element. The heating element may be heated by a current supply and may transfer heat to the liquid composition in contact with the heating element, thereby heating the liquid composition. As a result, aerosol may be generated.

For example, the vaporizer 14 may be referred to as a cartomizer or an atomizer, but it is not limited thereto.

The aerosol-generating device 1 may further include general-purpose components in addition to the battery 11, the controller 12, the heater 13, and the vaporizer 14. For example, the aerosol-generating device 1 may include a display capable of outputting visual information and/or a motor for outputting haptic information. Also, the aerosol-generating device 1 may include at least one sensor (a puff detecting sensor, a temperature detecting sensor, a cigarette insertion detecting sensor, etc.). Also, the aerosol-generating device 1 may be formed as a structure that, even when the cigarette 2 is inserted into the aerosol-generating device 1, may introduce external air or discharge internal air.

Although not illustrated in FIGS. 1 through 3, the aerosol-generating device 1 and an additional cradle may form together a system. For example, the cradle may be used to charge the battery 11 of the aerosol-generating device 1. Alternatively, the heater 13 may be heated when the cradle and the aerosol-generating device 1 are coupled to each other.

The cigarette 2 may be similar to a general combustive cigarette. For example, the cigarette 2 may be divided into a first portion including an aerosol generating material and a second portion including a filter, etc. Alternatively, the second portion of the cigarette 2 may also include an aerosol generating material. For example, an aerosol generating material made in the form of granules or capsules may be inserted into the second portion.

The entire first portion may be inserted into the aerosol-generating device 1, and the second portion may be exposed to the outside. Alternatively, only a portion of the first portion may be inserted into the aerosol-generating device 1, or the entire first portion and a portion of the second portion may be inserted into the aerosol-generating device 1. The user may puff aerosol while holding the second portion by the mouth of the user. In this case, the aerosol is generated by the external air passing through the first portion, and the generated aerosol passes through the second portion and is delivered to the user's mouth.

For example, the external air may flow into at least one air passage formed in the aerosol-generating device 1. For example, opening and closing of the air passage and/or a size of the air passage formed in the aerosol-generating device 1 may be adjusted by the user. Accordingly, the amount and the quality of smoking may be adjusted by the user. As another example, the external air may flow into the cigarette 2 through at least one hole formed in a surface of the cigarette 2.

Hereinafter, examples of the cigarette 2 will be described with reference to FIGS. 4 and 5.

FIGS. 4 and 5 illustrate examples of a cigarette.

Referring to FIG. 4, the cigarette 2 may include a tobacco rod 21 and a filter rod 22. The first portion described above with reference to FIGS. 1 through 3 may include the tobacco rod 21, and the second portion may include the filter rod 22.

FIG. 4 illustrates that the filter rod 22 includes a single segment. However, the filter rod 22 is not limited thereto. In other words, the filter rod 22 may include a plurality of segments. For example, the filter rod 22 may include a first segment configured to cool an aerosol and a second segment configured to filter a certain component included in the aerosol. Also, according to necessity, the filter rod 22 may further include at least one segment configured to perform other functions.

The diameter of the cigarette 2 may be within the range of about 5 mm to about 9 mm and the length of the cigarette 2 may be about 48 mm. However, the disclosure is not limited thereto. For example, the length of the tobacco rod 21 may be about 12 mm, the length of the first segment of the filter rod 22 may be about 10 mm, the length of the second segment of the filter rod 22 may be about 14 mm, and the length of the third segment of the filter rod 22 may be about 12 mm. However, disclosure is not limited thereto.

The cigarette 2 may be packaged via at least one wrapper 24. The wrapper 24 may have at least one hole through which external air may be introduced or internal air may be discharged. For example, the cigarette 2 may be packaged via one wrapper 24. As another example, the cigarette 2 may be doubly packaged via at least two wrappers 24. For example, the tobacco rod 21 may be packaged via a first wrapper 241, and the filter rod 22 may be packaged via second wrappers 242, 243, and 244. Also, the entire cigarette 2 may be packaged via a single wrapper 245. When the filter rod 22 includes a plurality of segments, each segment may be packaged via each of the second wrappers 242, 243, and 244.

The first wrapper 241 and the second wrapper 242 may each include general tilter wrapping paper. For example, the first wrapper 241 and the second wrapper 242 may each include porous wrapping paper or non-porous wrapping paper. In addition, the first wrapper 241 and the second wrapper 242 may each include paper having oil resistance and/or an aluminum laminate packaging material.

The third wrapper 243 may include hard wrapping paper. For example, the basis weight of the third wrapper 243 may be in the range of about 88 g/m² to about 96 g/m², specifically in the range of about 90 g/m² to about 94 g/m². In addition, the thickness of the third wrapper 243 may be in the range of about 120 um to about 130 um, specifically 125 um.

The fourth wrapper 244 may include oil-resistant hard wrapping paper. For example, the basis weight of the fourth wrapper 244 may be in the range of about 88 g/m² to about 96 g/m², specifically in the range of about 90 g/m² to about 94 g/m². In addition, the thickness of the fourth wrapper 244 may be in the range of about 120 um to about 130 um, specifically 125 um.

The fifth wrapper 245 may include sterile paper (MFW). Here, the sterile paper (MFW) refers to a paper specially prepared so that tensile strength, water resistance, smoothness, etc. thereof are further improved compared to those of general paper. For example, the basis weight of the fifth wrapper 245 may be in the range of about 57 g/m² to about 63 g/m², specifically 60 g/m² In addition, the thickness of the fifth wrapper 245 may be in the range of about 64 um to about 70 um, specifically 67 um.

A certain material may be internally added to the fifth wrapper 245. Here, an example of the certain material may include silicon, but is not limited thereto. For example, silicon has characteristics, such as heat resistance with little change with temperature, resistance to oxidation, resistance to various chemicals, water repellency against water, or electrical insulation. However, even though the certain material is not silicon, any material having the characteristics described above may be applied to (or coated on) the fifth wrapper 245 without limitation.

The fifth wrapper 245 may prevent the cigarette 2 from burning. For example, when the tobacco rod 21 is heated by the heater 13, there is a possibility that the cigarette 2 is burned. Specifically, when the temperature rises above the ignition point of any one of the materials included in the tobacco rod 21, the cigarette 2 may be burned. Even in this case, because the fifth wrapper 245 includes a non-combustible material, a burning phenomenon of the cigarette 2 may be prevented.

In addition, the fifth wrapper 245 may prevent a holder 1 from being contaminated by substances generated in the cigarette 2. By a user's puff, liquid substances may be generated in the cigarette 2. For example, as an aerosol generated in the cigarette 2 is cooled by the outside air, liquid substances (e.g., moisture, etc.) may be generated. As the fifth wrapper 245 wraps the cigarette 2, the liquid substances generated in the cigarette 2 may be prevented from leaking out of the cigarette 2.

The tobacco rod 21 includes an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. Also, the tobacco rod 210 may include other additives, such as flavors, a wetting agent, and/or organic acid. Also, the tobacco rod 210 may include a flavored liquid, such as menthol or a moisturizer, which is injected to the tobacco rod 210.

The tobacco rod 21 may be formed in various ways. For example, the tobacco rod 21 may be formed as a sheet or a strand. Also, the tobacco rod 21 may be formed as a pipe tobacco, which is formed of tiny bits cut from a tobacco sheet. Also, the tobacco rod 21 may be surrounded by a heat conductive material. For example, the heat-conducting material may be, but is not limited to, a metal foil such as aluminum foil. For example, the heat conductive material surrounding the tobacco rod 21 may uniformly distribute heat transmitted to the tobacco rod 21, and thus, the heat conductivity applied to the tobacco rod 21 may be increased and taste of the tobacco may be improved. Also, the heat conductive material surrounding the tobacco rod 21 may function as a susceptor heated by the induction heater. Here, although not illustrated in the drawings, the tobacco rod 21 may further include an additional susceptor, in addition to the heat conductive material surrounding the tobacco rod 21.

The filter rod 22 may include a cellulose acetate filter. Shapes of the filter rod 22 are not limited. For example, the filter rod 22 may include a cylinder-type rod or a tube-type rod having a hollow inside. Also, the filter rod 22 may include a recess-type rod. When the filter rod 22 includes a plurality of segments, at least one of the plurality of segments may have a different shape.

The first segment of the filter rod 22 may include a cellulose acetate filter. For example, the first segment may include a tube-shaped structure including a hollow therein. When the heater 13 is inserted by the first segment, the inner material of the tobacco rod 21 may be prevented from being pushed back, and a cooling effect of the aerosol may occur. The diameter of the hollow included in the first segment may be an appropriate diameter within the range of about 2 mm to about 4.5 mm, but is not limited thereto.

The length of the first segment may be an appropriate length within the range of about 4 mm to about 30 mm, but is not limited thereto. Specifically, the length of the first segment may be 10 mm, but is not limited thereto.

The hardness of the first segment may be adjusted by adjusting the content of a plasticizer in the manufacture of the first segment. In addition, the first segment may be manufactured by inserting a structure, such as a film or a tube including the same material or different materials, inside the first segment (e.g., into the hollow).

The second segment of the filter rod 22 cools the aerosol generated as the heater 13 heats the tobacco rod 21. Thus, a user may inhale the aerosol cooled to a suitable temperature.

The length or diameter of the second segment may be variously determined according to the shape of the cigarette 2. For example, the length of the second segment may be appropriately determined within the range of about 7 mm to about 20 mm. Specifically, the length of the second segment may be about 14 mm, but is not limited thereto.

The second segment may be fabricated by weaving polymer fibers. In this case, a flavored liquid may be applied to fibers made of polymer. Alternatively, the second segment may be fabricated by weaving a fiber to which a flavored liquid is applied and a fiber made of a polymer together. Alternatively, the second segment may be formed by a crimped polymer sheet.

For example, the polymer may include a material selected from the group consisting of polyethylene (PE), polypropylene (PP), polyvinyl chloride (PVC), polyethylene terephthalate (PET), polylactic acid (PLA), cellulose acetate (CA), and aluminum foil.

As the second segment is formed by a woven polymer fiber or crimped polymer sheet, the second segment may include a single channel or a plurality of channels extending in a longitudinal direction thereof. Here, the channel refers to a passage through which a gas (e.g., air or aerosol) passes.

For example, the second segment formed by the crimped polymer sheet may be formed from a material having a thickness between about 5 pm and about 300 pm, such as between about 10 pm and about 250 pm. Also, the total surface area of the second segment may be between about 300 mm²/mm and about 1000 mm²/mm. Furthermore, an aerosol cooling element may be formed from a material having a specific surface area between about 10 mm²/mg and about 100 mm²/mg.

The second segment may include a thread containing a volatile flavor ingredient. Here, the volatile flavor ingredient may be menthol, but is not limited thereto. For example, the thread may be filled with a sufficient amount of menthol to provide 1.5 mg or more of menthol to the second segment.

The third segment of the filter rod 22 may include a cellulose acetate filter. The length of the third segment may be appropriately determined within the range of about 4 mm to about 20 mm. For example, the length of the third segment may be about 12 mm, but is not limited thereto.

The third segment may be fabricated such that flavor is generated by spraying a flavored liquid on the third segment in the process of fabricating the third segment. Alternatively, a separate fiber to which a flavored liquid is applied may be inserted into the third segment. The aerosol generated by the tobacco rod 21 is cooled as the aerosol passes through the second segment of the filter rod 22, and the cooled aerosol is delivered to a user through the third segment. Accordingly, when a flavoring element is added to the third segment, an effect of enhancing the durability of a flavor delivered to the user may occur.

Also, the filter rod 22 may include at least one capsule 23. Here, the capsule 23 may generate a flavor or an aerosol. For example, the capsule 23 may have a configuration in which a liquid containing a flavoring material is wrapped with a film. For example, the capsule 23 may have a spherical or cylindrical shape, but is not limited thereto.

Referring to FIG. 5, the cigarette 2 may further include a front-end filter 33 that is a front-end plug. The front-end filter 33 may be located on a side of the tobacco rod 21, the side facing the filter rod 22. The front-end filter 33 may prevent the tobacco rod 31 from being detached outwards and prevent a liquefied aerosol from flowing into the aerosol-generating device 1 (FIGS. 1 through 3) from the tobacco rod 21, during smoking.

The filter rod 32 may include a first segment 321 and a second segment 322. Here, the first segment 321 may correspond to the first segment of the filter rod 22 of FIG. 4, and the second segment 322 may correspond to the third segment of the filter rod 22 of FIG. 4.

The total length and diameter of the cigarette 3 may correspond to the total length and diameter of the cigarette 2 of FIG. 4. For example, the length of the front-end filter 33 may be about 7 mm, the length of the tobacco rod 31 may be about 15 mm, the length of the first segment 321 may be about 12 mm, and the length of the first segment 322 may be about 14 mm, but the embodiments are not limited thereto.

The cigarette 3 may be packaged via at least one wrapper 35. The wrapper 35 may have at least one hole through which external air may be introduced or internal air may be discharged. For example, the front-end filter 33 may be packaged via a first wrapper 351, the filter rod 31 may be packaged via a second wrapper 352, the first segment 321 may be packaged via a third wrapper 353, and the second segment 322 may be packaged via a fourth wrapper 354. Additionally, a whole part of the cigarette 3 may be packaged by a fifth wrapper 355.

Also, the fifth wrapper 355 may have at least one through hole 36. For example, the through hole 36 may be formed at a portion of the fifth wrapper 355 surrounding the tobacco rod 31. The through hole 36 may perform a function of transmitting heat generated by the heater 31 shown in FIGS. 2 and 3 to the inside of the tobacco rod 31.

Also, the second segment 322 may include at least one capsule 34. Here, the capsule 34 may perform a function of generating a flavor or another function of generating aerosol. For example, the capsule 34 may have a configuration in which a liquid containing a flavoring material is wrapped with a film. For example, the capsule 34 may have a spherical or cylindrical shape, but is not limited thereto.

The first wrapper 351 may include general filter wrapping paper to which a metal foil such as an aluminum foil is coupled. For example, the total thickness of the first wrapper 351 may be in the range of about 45 um to about 55 um, specifically 50.3 um. In addition, the thickness of the metal foil of the first wrapper 351 may be in the range of about 6 um to about 7 um, specifically 6.3 um. In addition, the basis weight of the first wrapper 351 may be in the range of about 50 g/m² to about 55 g/m², specifically 53 g/m².

The second wrapper 352 and the third wrapper 353 may each include general filter wrapping paper. For example, the second wrapper 352 and the third wrapper 353 may each include porous wrapping paper or non-porous wrapping paper.

For example, the porosity of the second wrapper 352 may be 35,000 CU, but is not limited thereto. In addition, the thickness of the second wrapper 352 may be in the range of about 70 um to about 80 um, specifically 78 um. In addition, the basis weight of the second wrapper 352 may be in the range of about 20 g/m² to about 25 g/m², specifically 23.5 g/m².

For example, the porosity of the third wrapper 353 may be 24,000 CU, but is not limited thereto. In addition, the thickness of the third wrapper 353 may be in the range of about 60 um to about 70 um, specifically 68 um. In addition, the basis weight of the third wrapper 353 may be in the range of about 20 g/m² to about 25 g/m², specifically 21 g/m².

The fourth wrapper 354 may include PLA laminated paper. Here, the PLA laminated paper refers to a three-ply paper including a paper layer, a PLA layer, and a paper layer. For example, the thickness of the fourth wrapper 354 may be in the range of about 100 um to about 120 um, specifically I10 um. In addition, the basis weight of the fourth wrapper 354 may be in the range of about 80 g/m² to about 100 g/m², specifically 88 g/m².

The fifth wrapper 355 may include sterilized paper (MFW). Here, the sterile paper (MFW) refers to a paper specially prepared so that tensile strength, water resistance, smoothness, etc. thereof are further improved compared to those of general paper. For example, the basis weight of the fifth wrapper 355 may be in the range of about 57 g/m² to about 63 g/m², specifically 60 g/m². In addition, the thickness of the fifth wrapper 355 may be in the range of about 64 um to about 70 um, specifically 67 um.

A certain material may be internally added to the fifth wrapper 355. Here, an example of the certain material may include, but is not limited thereto. For example, silicon has characteristics, such as heat resistance with little change with temperature, resistance to oxidation, resistance to various chemicals, water repellency against water, or electrical insulation. However, even though the certain material is not silicon, any material having the characteristics described above may be applied to (or coated on) the fifth wrapper 355 without limitation.

The shear plug 33 may include cellulose acetate. As an example, the front-end filter 33 may be fabricated by adding a plasticizer (e.g., triacetin) to a cellulose acetate tow. The mono denier of a filament constituting the cellulose acetate tow may be in the range of about 1.0 to about 10.0, specifically in the range of about 4.0 to about 6.0. More specifically, the mono denier of the filament of the front-end filter 33 may be 5.0. In addition, the cross-section of the filament constituting the front-end filter 33 may have a Y-shape. The total denier of the front-end filter 33 may be in the range of about 20,000 to about 30,000, preferably in the range of about 25,000 to about 30,000. More specifically, the total denier of the front-end filter 33 may be 28,000.

In addition, if necessary, the front-end filter 33 may include at least one channel, and the cross-section of the channel may have various shapes.

The tobacco rod 31 may correspond to the tobacco rod 21 described above with reference to FIG. 4. Therefore, a detailed description of the tobacco rod 31 is omitted below.

The first segment 321 may include cellulose acetate. For example, the first segment may include a tube-shaped structure including a hollow therein. The first segment 321 may be fabricated by adding a plasticizer (e.g., triacetin) to the cellulose acetate tow. For example, the mono denier and total denier of the first segment 321 may be the same as the mono denier and total denier of the front-end filter 33.

The second segment 322 may include cellulose acetate. The mono denier of a filament constituting the second segment 322 may be in the range of about 1.0 to about 10.0, specifically in the range of about 8.0 to about 10.0. More specifically, the mono denier of the filament of the second segment 322 may be 9.0. In addition, the cross-section of the filament of the second segment 322 may have a Y-shape. The total denier of the second segment 322 may be in the range of about 20,000 to about 30,000, specifically 25,000.

FIG. 6 is a schematic block diagram of an aerosol-generating apparatus according to an embodiment.

Referring to FIG. 6, the aerosol-generating apparatus includes a controller 610, a temperature sensor 620, and a heater 630. Components of the aerosol-generating apparatus are not limited thereto, and according to one or more embodiments, other components may be added thereto, or at least one component may be omitted.

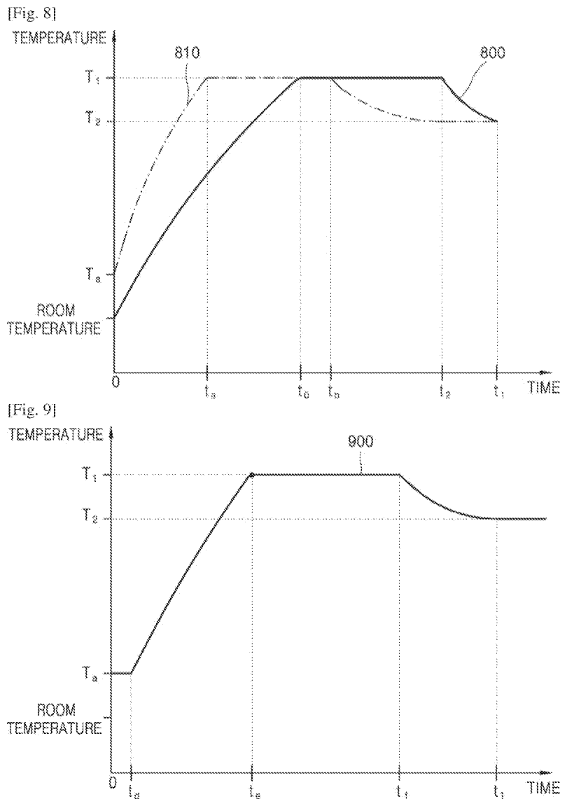

When a temperature of the heater 630 is lower than a reference temperature, the aerosol-generating apparatus may control power supply to the heater 630 according to a predefined first preheating profile. When a temperature of the heater 630 is higher than or equal to the reference temperature, the aerosol-generating apparatus controls the power supply to the heater 630 according to a second preheating profile that is different from the first preheating profile. The aerosol-generating apparatus supplies power to the heater according to a predefined preheating profile under general conditions, e.g., at room temperature, and according to another preheating profile under a specific condition, e.g., when the temperature of the heater is high. The term “preheating profile” indicates a profile defining a preset preheating time and a preset preheating temperature. The first preheating profile and the second preheating profile are described below with reference to FIGS. 8 and 9.

A case where the temperature of the heater 630 is higher than or equal to the reference temperature may indicate that, for example, a device is continuously used or continued smoking is performed. For example, a second smoking series starts within a short period of time after a first smoking series is terminated.

In an embodiment, a case where the temperature of the heater 630 is higher than or equal to the reference temperature is described, but other preheating profiles may be applied even to a case where the temperature of the heater 630 is less than the reference temperature or another reference temperature, which is different from a general condition.

The temperature sensor 620 may measure the temperature of the heater 630. For example, the temperature sensor 620 may be a contact temperature sensor for measuring the temperature of the heater 630 in contact therewith or a non-contact temperature sensor for measuring the temperature of the heater 630 without contacting the same. The contact temperature sensor may be a thermocouple, a resistance temperature detector (RTD), a thermistor, or a temperature label, and the non-contact temperature sensor may be an infrared temperature sensor. In an embodiment, it is described that the temperature sensor 620 measures the temperature of the heater 630, but one or more embodiments are not limited thereto. The temperature sensor 620 may measure the temperature of the heater 630 around the heater 630 or at a location close thereto.

The heater 630 may heat at least a portion of the aerosol-generating article. The heater 630 may be of various types described above with reference to FIGS. 1 to 3. The heater 630 may heat at least a portion of the aerosol-generating article as power is supplied to the heater 630 under the control of the controller 610. At least a portion of the aerosol-generating article may be a tobacco rod including an aerosol-generating material and/or a tobacco material. In an embodiment, the heater 630 may receive power through the controller 610 according to temperature profiles corresponding to a preheating section and a heating section.

The controller 610 may control overall operations of the aerosol-generating apparatus. In an embodiment, the controller 610 may detect a smoking action of a user. In this case, the expression “first smoking series,” “second smoking series,” or “smoking action of a user” may indicate that a user takes a predetermined number of puffs (e.g., 14 times) on one aerosol-generating article. For example, the controller 610 may detect a continuous smoking action of the user based on the temperature of the heater 630 which is measured by the temperature sensor 620. As another example, the controller 610 may detect a continuous smoking action of the user based on a time measured by a timer (not shown). That is, when the second smoking series continues within a certain period of time, e.g., 3 seconds, after the first smoking series is terminated, it may be determined that a continuous smoking action is performed.

When the aerosol-generating article is inserted into the aerosol-generating apparatus, the controller 610 may measure the temperature of the heater 630 and determine whether the temperature of the heater 630 is higher than or equal to the reference temperature. In an embodiment, the controller 610 may determine whether the user intends to start a smoking action by determining whether the aerosol-generating article is inserted by using a cigarette insertion detecting sensor. In another embodiment, when a user input for initiating the aerosol-generating apparatus is received, e.g., an operation initiation button or a power button is pressed, the controller 610 may measure the temperature of the heater 630 and determine whether the temperature of the heater 630 is higher than or equal to the reference temperature.

The controller 610 may control the power supply to the heater 630 according to the user's smoking action. For example, the controller 610 may detect whether the user's smoking action is an initial smoking action or a continuous smoking action performed after the initial smoking action and may control the power supply to the heater 630 according to a detection result.

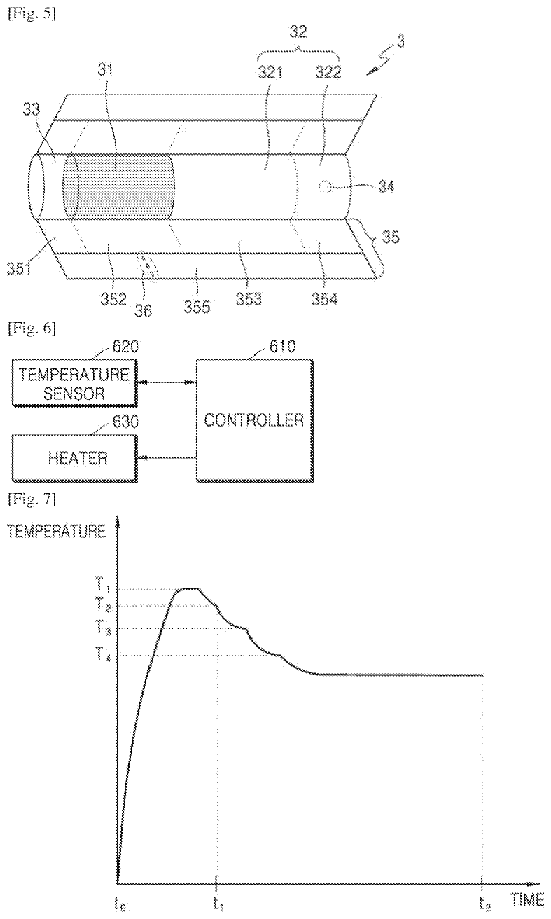

FIG. 7 is an example diagram for explaining a temperature profile in the entire heating section of an aerosol-generating apparatus.

FIG. 7 shows a temperature profile in the entire heating section including a preheating section between t0 and t1 and a heating section between t1 and t2. When a smoking action starts in the aerosol-generating apparatus, power is supplied to a heater according to temperature profiles that define time-specific temperature values, as shown in FIG. 7. The preheating section and the heating section may each be subdivided.

The preheating section may include a first preheating section in which the temperature of the heater increases to a first target temperature T1, a second preheating section in which the first target temperature T1 is maintained, and a third preheating section in which the temperature of the heater decreases to a second target temperature T2. The heating section may include a first heating section in which the temperature of the heater decreases to a third target temperature T3, a second heating section in which the temperature of the heater decreases to a fourth target temperature T4, and a third heating section in which the fourth target temperature T4 is maintained. It is described that the preheating section includes the first preheating section, the second preheating section, and the third preheating section. However, one or more embodiments are not limited thereto, and various modifications may be made according to a shape or type of an aerosol-generating article or a heater.

The preheating section or the preheating profile of FIG. 7 is described in detail with reference to FIGS. 8 and 9.

FIG. 8 is an example diagram for explaining an example of a preheating section of the temperature profile of FIG. 7. FIG. 8 shows a first preheating profile 800 and a second preheating profile 810.

The first preheating profile 800 specifies a preheating time and a preheating temperature during a preset preheating time t1, which are pre-set. The aerosol-generating apparatus controls the power supply to the heater according to the first preheating profile 800. As shown in FIG. 8, according to the first preheating profile 800, the temperature increases to reach the first target temperature T1 at time t0, the first target temperature T1 is maintained until time t2, and the temperature decreases to reach the second target temperature T2 at time t1. For example, when the preheating time is set to be about 37 seconds, the temperature increases to about 270° C. in about 19 seconds, then is maintained at 270° C. for 11 seconds, and decreases to 225° C. in 7 seconds. The preheating time and the target temperatures are merely examples, and one or more embodiments are not limited thereto.

According to the second preheating profile 810, the temperature increases to reach the first target temperature T1 at time ta, the first target temperature T1 is maintained until time t2, and the temperature decreases to reach the second target temperature T2 at time t2. The start temperature Ta in the second preheating profile 810 is higher than the start temperature in the first preheating profile 800 which is room temperature (i.e., about 15° C.). Therefore, the second preheating profile 810 reaches the first target temperature T1 faster than the first preheating profile 800. In this case, the aerosol-generating apparatus is maintained at a high temperature at the early stage, and thus the user may feel uncomfortable because of the heat.

In an embodiment, a preheating time of the second preheating profile 810 after the first target temperature T1 is reached is longer than that of the first preheating profile 800, and thus the initial heat may be reduced.

As shown in FIG. 8, the preheating time of the second preheating profile 810 after the first target temperature T1 is reached is t1-ta, and the preheating time of the first preheating profile 800 after the first target temperature T1 is reached is t1-t0. Here, the preheating time t1-ta is longer than the preheating time t1-t0. Also, a temporal section tb-ta of the second preheating profile 810, during which the first target temperature T1 is maintained, may be less than a temporal section t2-t0 of the first preheating profile 800, during which the first target temperature T1 is maintained. Also, a temporal section t1-tb of the second preheating profile 810, during which the temperature decreases to the second target temperature T2, may be longer than a temporal section t1-t2 of the first preheating profile 800.

A length of a temporal section of the second preheating profile 810 during which the first target temperature T1 is maintained and then decreases to the second target temperature T2 may vary according to a value of the start temperature Ta. For example, when the start temperature Ta is high, the length of the temporal section increases. On the other hand, when the start temperature Ta is low, the length of the temporal section decreases. Also, a ratio of the temporal section during which the first target temperature T1 is maintained to the temporal section during which the temperature decreases to the second target temperature T2 may be adjusted according to the value of the start temperature Ta.

In an embodiment, when a current temperature of the heater is lower than the reference temperature, that is, when the aerosol-generating apparatus operates under general conditions, the aerosol-generating apparatus supplies power to the heater according to the first preheating profile 800. When the temperature of the heater is higher than or equal to the reference temperature, that is, when the aerosol-generating apparatus operates under a high temperature condition, the aerosol-generating apparatus supplies power to the heater according to the second preheating profile. The high temperature condition includes a high ambient temperature, continuous use of the aerosol-generating apparatus, etc. Therefore, as a preheating profile is adaptively selected according to the current temperature of the heater, the aerosol-generating apparatus may prevent the user from feeling heat during an initial puff and provide a sufficient amount of aerosol.

FIG. 9 is an example diagram for explaining another example of a preheating section of the temperature profile of FIG. 7.

Referring to FIG. 9, another second preheating profile 910 different from the second preheating profile 810 of FIG. 7 is shown. As shown in FIG. 9, when the initial start temperature Ta is higher than the room temperature, the second preheating profile 900 is configured to increase the temperature to reach the first target temperature T1 at time te after the delay time td, maintain the first target temperature T1 until time tf, and decrease the temperature to reach the second target temperature T2 at time t1.

In an embodiment, because the second preheating profile 900 starts at the temperature Ta higher than the room temperature, the temperature may increase to the first target temperature T1 after a certain delay time td. In this case, a length of the delay time td may differ according to the measured temperature (i.e., initial start temperature Ta) of the heater. For example, when the initial start temperature Ta is high, the length of the delay time td may increase, and when the initial start temperature Ta is low, the length of the delay time td may decrease. Also, a length of the temporal section during which the first target temperature T1 is maintained or the temporal section during which the temperature decreases to the second target temperature T2 may be adjusted according to the length of the delay time td.

In an embodiment, the temporal section tf-te of the second preheating profile 900, during which the first target temperature T1 is maintained, may be longer than the temporal section t2-t0 of the first preheating profile 800 of FIG. 8, during which the first target temperature T1 is maintained. Also, a temporal section t1-tf of the second preheating profile 900, during which the temperature of the heater decreases to the second target temperature T2, may be longer than the temporal section t1-t2 of the first preheating profile 800 of FIG. 8, during which the temperature of the heater decreases to the second target temperature T2. Thereby, although the initial temperature of the heater is high, the initial heat the user may feel may be reduced.

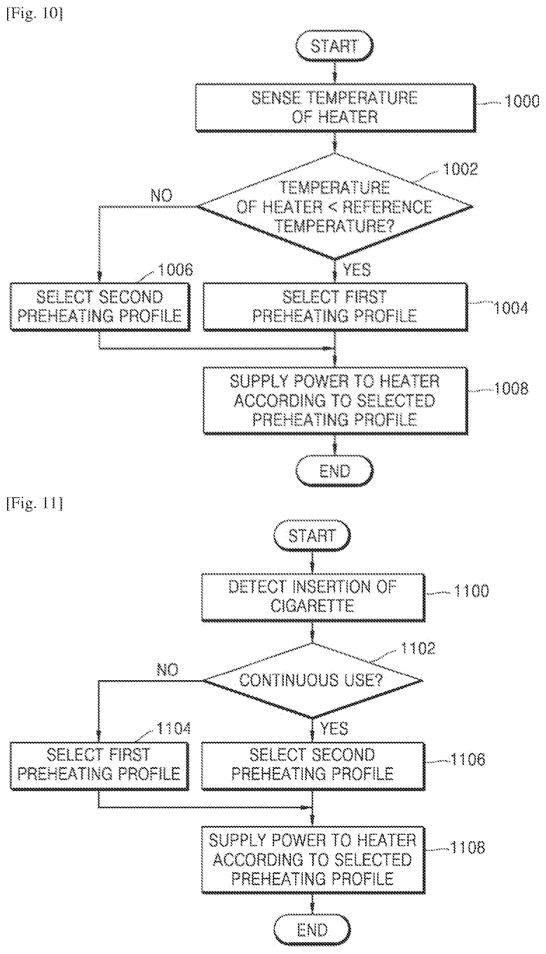

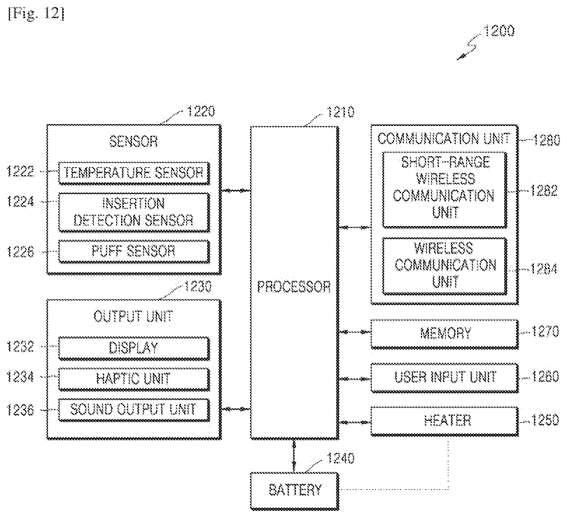

FIG. 10 is a flowchart of a method of controlling an aerosol-generating apparatus, according to another embodiment.

Referring to FIG. 10, in operation 1000, a temperature of a heater is measured.

In operation 1002, the measured temperature of the heater is compared with a reference temperature. When the temperature of the heater is lower than the reference temperature in operation 1002, a first preheating profile is selected in operation 1004. Here, the reference temperature is a temperature that may be arbitrarily set. For example, the reference temperature may be set to about 17° C. that corresponds to the room temperature. Also, the temperature of the heater may be compared with a specific temperature range instead of a specific temperature value. The first preheating profile may be used under general conditions and may define a target temperature associated with a predefined time.

When the measured temperature of the heater is higher than or equal to the reference temperature in operation 1002, a second preheating profile is selected in operation 1006. When a currently measured temperature of the heater is higher than or equal to the reference temperature, the second preheating profile different from the first preheating profile is selected. The temporal section during which the target temperature is maintained and/or the temporal section during which the temperature of the heater decreases to a lower temperature may be longer in the second preheating profile than in the first preheating profile.

In operation 1008, power is supplied to the heater according to the preheating profile selected in operation 1004 or operation 1006.

FIG. 11 is a flowchart of a method of controlling an aerosol-generating apparatus, according to another embodiment.

Referring to FIG. 11, in operation 1100, the insertion of a cigarette in the aerosol-generating apparatus is detected. As the insertion of the cigarette is detected, it may be predicted that the aerosol-generating apparatus will be used. In an embodiment, as the insertion of the cigarette is detected, the aerosol-generating apparatus may be powered on, or the heater may start being heated. When the cigarette is inserted, it may be determined whether the aerosol-generating apparatus is being continuously used in operation 1102. Continuous use may indicate that a cigarette is inserted again within a certain period of time after the previous smoking series is terminated. The continuous use may be detected when a temperature of a heater is higher than or equal to a reference temperature. Also, the continuous use may be detected when a cigarette is inserted again within a certain period of time after the previous smoking series is terminated.

When the continuous use is not detected in operation 1102, the first preheating profile is selected in operation 1104.

When the continuous use is detected in operation 1102, the second preheating profile is selected in operation 1106.

In operation 1108, power is supplied to the heater according to the preheating profile selected in operation 1104 or operation 1106.

FIG. 12 is a block diagram of an aerosol-generating device 1200 according to another embodiment.

Referring to FIG. 12, the aerosol-generating device 1200 may include a controller 1210, a sensing unit 1220, an output unit 1230, a battery 1240, a heater 1050, a user input unit 1260, a memory 1270, a communication unit 1280. However, the internal structure of the aerosol-generating device 1200 is not limited to that shown in FIG. 12. That is, it will be understood by one of ordinary skill in the art that some of the components shown in FIG. 12 may be omitted or new components may be added according to the design of the aerosol-generating device 1200.

The sensing unit 1220 may sense a state of the aerosol-generating device 1200 or a state around the aerosol-generating device 1200, and transmit sensed information to the controller 1210. Based on the sensed information, the controller 1210 may control the aerosol-generating device 1200 to perform various functions, such as controlling an operation of the heater 1250, limiting smoking, determining whether an aerosol-generating article (e.g., a cigarette, a cartridge, or the like) is inserted, displaying a notification, or the like.

The sensing unit 1220 may include at least one of a temperature sensor 1222, an insertion detection sensor 1224, and a puff sensor 1226, but is not limited thereto.

The temperature sensor 1222 may sense a temperature at which the heater 1250 (or an aerosol generating material) is heated. The aerosol-generating device 1200 may include a separate temperature sensor for sensing the temperature of the heater 1250, or the heater 1250 may serve as a temperature sensor. Alternatively, the temperature sensor 1222 may also be arranged around the battery 1240 to monitor the temperature of the battery 1240. In an embodiment, the temperature sensor 1222 may measure the temperature of the heater 1250 before being heated.

The insertion detection sensor 1224 may sense insertion and/or removal of an aerosol-generating article. For example, the insertion detection sensor 1224 may include at least one of a film sensor, a pressure sensor, an optical sensor, a resistive sensor, a capacitive sensor, an inductive sensor, and an infrared sensor, and may sense a signal change according to the insertion and/or removal of an aerosol-generating article. In an embodiment, the insertion detection sensor 1224 may determine continuous use when, after detecting insertion of an aerosol-generating article, it detects insertion of an aerosol-generating article again within a predetermined period of time after the one-smoke series ends.

The puff sensor 1226 may sense a user's puff based on various physical changes in an airflow passage or an airflow channel. For example, the puff sensor 1226 may sense a user's puff based on any one of a temperature change, a flow change, a voltage change, and a pressure change.

The sensing unit 1220 may include, in addition to the temperature sensor 1222, the insertion detection sensor 1224, and the puff sensor 1226 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 1230 may output information on a state of the aerosol-generating device 1200 and provide the information to a user. The output unit 1230 may include at least one of a display unit 1232, a haptic unit 1234, and a sound output unit 1236, but is not limited thereto. When the display unit 1232 and a touch pad form a layered structure to form a touch screen, the display unit 1232 may also be used as an input device in addition to an output device.

The display unit 1232 may visually provide information about the aerosol-generating device 1200 to the user. For example, information about the aerosol-generating device 1200 may mean various pieces of information, such as a charging/discharging state of the battery 1240 of the aerosol-generating device 1200, a preheating state of the heater 1250, an insertion/removal state of an aerosol-generating article, or a state in which the use of the aerosol-generating device 1200 is restricted (e.g., sensing of an abnormal object), or the like, and the display unit 1232 may output the information to the outside. The display unit 1232 may be, for example, a liquid crystal display (LCD) panel, an organic light-emitting diode (OLED) display panel, or the like. In addition, the display unit 1232 may be in the form of a light-emitting diode (LED) device.

The haptic unit 1234 may tactilely provide information about the aerosol-generating device 1200 to the user by converting an electrical signal into a mechanical stimulus or an electrical stimulus. For example, the haptic unit 1234 may include a motor, a piezoelectric element, or an electrical stimulation device.

The sound output unit 1236 may audibly provide information about the aerosol-generating device 1200 to the user. For example, the sound output unit 1236 may convert an electrical signal into a sound signal and output the same to the outside.

The battery 1240 may supply power used to operate the aerosol-generating device 1200. The battery 1240 may supply power such that the heater 1250 may be heated. In addition, the battery 1240 may supply power required for operations of other components (e.g., the sensing unit 1220, the output unit 1230, the user input unit 1260, the memory 1270, and the communication unit 1280) in the aerosol-generating device 1200. The battery 1240 may be a rechargeable battery or a disposable battery. For example, the battery 1240 may be a lithium polymer (LiPoly) battery, but is not limited thereto.

The heater 1250 may receive power from the battery 1240 to heat an aerosol generating material. Although not illustrated in FIG. 12, the aerosol-generating device 1200 may further include a power conversion circuit (e.g., a direct current (DC)/DC converter) that converts power of the battery 1240 and supplies the same to the heater 1250. In addition, when the aerosol-generating device 1200 generates aerosols in an induction heating method, the aerosol-generating device 1200 may further include a DC/AC converter that converts DC power of the battery 1240 into AC power.

The controller 1210, the sensing unit 1220, the output unit 1230, the user input unit 1260, the memory 1270, and the communication unit 1280 may each receive power from the battery 1240 to perform a function. Although not illustrated in FIG. 12, the aerosol-generating device 1200 may further include a power conversion circuit that converts power of the battery 1240 to supply the power to respective components, for example, a low dropout (LDO) circuit, or a voltage regulator circuit.

In an embodiment, the heater 1250 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 1250 may be implemented by a metal wire, a metal plate on which an electrically conductive track is arranged, a ceramic heating element, or the like, but is not limited thereto.

In another embodiment, the heater 1250 may be a heater of an induction heating type. For example, the heater 1250 may include a susceptor that heats an aerosol generating material by generating heat through a magnetic field applied by a coil.

In an embodiment, the heater 1250 may include a plurality of heaters. For example, the heater 1250 may include a first heater for heating a cigarette and a second heater for heating a liquid composition.

The user input unit 1260 may receive information input from the user or may output information to the user. For example, the user input unit 1260 may include a key pad, a dome switch, a touch pad (a contact capacitive method, a pressure resistance film method, an infrared sensing method, a surface ultrasonic conduction method, an integral tension measurement method, a piezoelectric effect method, or the like), a jog wheel, a jog switch, or the like, but is not limited thereto. In addition, although not illustrated in FIG. 12, the aerosol-generating device 1200 may further include a connection interface, such as a universal serial bus (USB) interface, and may connect to other external devices through the connection interface, such as the USB interface, to transmit and receive information, or to charge the battery 1240.

The memory 1270 is a hardware component that stores various types of data processed by the aerosol-generating device 1200, and may store data processed and data to be processed by the controller 1210. The memory 1270 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 1270 may store an operation time of the aerosol-generating device 1200, the maximum number of puffs, the current number of puffs, at least one temperature profile, data about a user's smoking pattern, etc. In an embodiment, the memory 1270 may store a plurality of temperature profiles. In addition, the memory 1270 may store a plurality of preheating profiles defining preheating sections among temperature profiles. The memory 1270 may store a plurality of preheating profiles described with reference to FIGS. 8 and 9.

The communication unit 1280 may include at least one component for communication with another electronic device. For example, the communication unit 1280 may include a short-range wireless communication unit 1282 and a wireless communication unit 1284.

The short-range wireless communication unit 1282 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or the like, but is not limited thereto.

The wireless communication unit 1284 may include a cellular network communication unit, an Internet communication unit, a computer network (e.g., local area network (LAN) or wide area network (WAN)) communication unit, or the like, but is not limited thereto. The wireless communication unit 1284 may also identify and authenticate the aerosol-generating device 1200 within a communication network by using subscriber information (e.g., International Mobile Subscriber Identifier (IMSI)).

The controller 1210 may control general operations of the aerosol-generating device 1200. In an embodiment, the controller 1210 may include at least one processor. The processor may be implemented as an array of a plurality of logic gates or may be implemented as a combination of a general-purpose microprocessor and a memory in which a program executable by the microprocessor is stored. It will be understood by one of ordinary skill in the art that the processor may be implemented in other forms of hardware.

The controller 1210 may control the temperature of the heater 1250 by controlling supply of power of the battery 1240 to the heater 1250. For example, the controller 1210 may control power supply by controlling switching of a switching element between the battery 1240 and the heater 1250. In another example, a direct heating circuit may also control power supply to the heater 1250 according to a control command of the controller 1210.

When the operation of the aerosol-generating device 1200 is started, the controller 1210 controls power supply to the heater 1250 according to a predetermined temperature profile or a predetermined preheating profile.

In an embodiment, when the operation of the aerosol-generating apparatus 1200 is initiated or when an aerosol-generating article is inserted, the controller 1210 measure a current temperature of the heater 1250 by using the temperature sensor 1222. When the temperature of the heater 1250 is higher than or equal to the reference temperature, the controller 1210 may load, from the memory 1270, a predefined preheating profile, that is, the second preheating profile that is different from the first preheating profile, and may control the power supply to the heater 1250 according to the second preheating profile.

In an embodiment, the controller 1210 may control the power supply to the heater 1250 according to a proportional-integral-differential (PID) control method. That is, the controller 1210 may control the power supply to the heater 1250 according to the PID control method so that the heater 1250 may have a temperature corresponding to the set temperature profile. For example, the controller 1210 may supply power by adjusting a parameter Kp regarding proportional control, a parameter Ki regarding integral control, and a parameter Kd regarding differential control or adjusting at least one of the aforementioned parameters to enable the temperature of the heater 1250 to increase to a target temperature during the time corresponding to a temperature increase section according to a temperature profile.

The controller 1210 may analyze a result of the sensing by the sensor 1220 and control processes to be performed subsequently. For example, the controller 1210 may control power supplied to the heater 1250 to initiate or terminate the operation of the heater 1250, based on the result of the sensing by the sensor 1220. As another example, based on the result of the sensing by the sensor 1220, the controller 1210 may control the amount of power supplied to the heater 1250 and the time at which the power is supplied, so that the heater 1250 is heated to a predetermined temperature or maintained at an appropriate temperature.

The controller 1210 may control the output unit 1230, based on the result of the sensing by the sensor 1220. For example, when the number of puffs counted by the puff sensor 1226 reaches the preset number, the controller 1210 may notify the user by using at least one of the display 1232, the haptic unit 1234, and the sound output unit 1236 that the aerosol-generating apparatus 1200 will soon be terminated.

In an embodiment, the controller 1210 may control the time at which the power is supplied and/or the amount of power supply, according to a state of the aerosol-generating article that is sensed by the sensor 1220. For example, when an aerosol-generating article is in an over-wet state, the controller 1210 may control the time, at which power is supplied to an induction coil, and thus increase the preheating time, compared to when the aerosol-generating article is in a normal state.

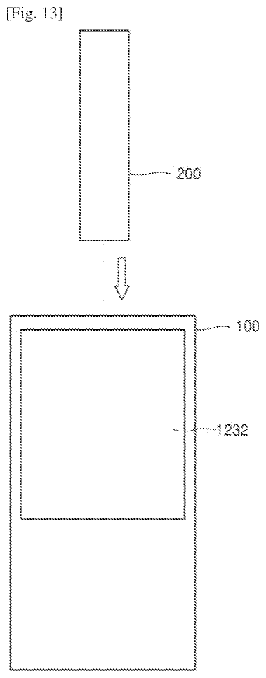

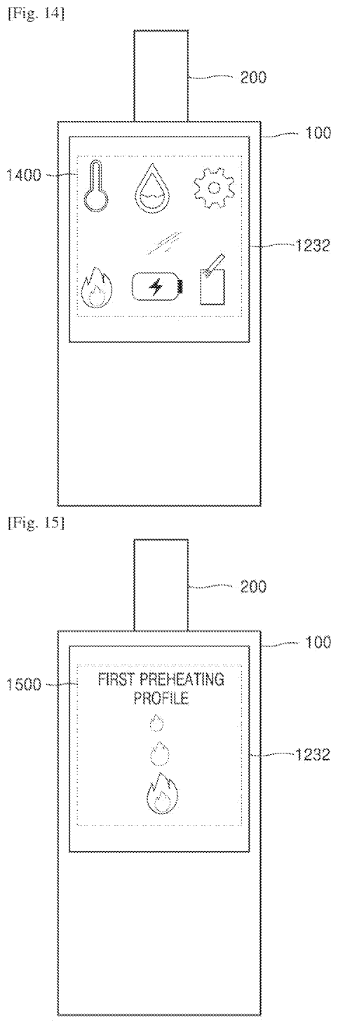

FIGS. 13 to 16 illustrate a preheating mode of the aerosol-generating apparatus of FIG. 12.

Referring to FIG. 13, an aerosol-generating article 200 is inserted in an accommodation portion of the aerosol-generating apparatus 100. A case where an aerosol-generating article of a cigarette type is vertically inserted is described, but one or more embodiments are not limited thereto. Also, the display 1232 may display information or an indicator, such as a state, conditions, user information, or the like of the aerosol-generating apparatus 100. The information or the indicator may be an icon or text. Also, as shown in FIG. 13, before the aerosol-generating article 200 is accommodated in the aerosol-generating apparatus 100, the display 1232 may be off.

Referring to FIG. 14, when the aerosol-generating article 200 is accommodated in the accommodation portion of the aerosol-generating apparatus 100, the aerosol-generating apparatus 100 may detect that the aerosol-generating article 200 is accommodated and thus may change a state of the display 1232 from an off state to an on state. In this case, the aerosol-generating apparatus 100 may be powered on or a heating operation is initiated. Then, power may start being supplied to the heater.

In an embodiment, when the aerosol-generating article 200 is inserted, the temperature of the heater is measured. When the temperature of the heater is lower than the reference temperature, the aerosol-generating apparatus 100 loads a first preheating profile from the memory 1270 and supplies power to the heater 1250 according to the first preheating profile. The first preheating profile defines a preheating time and a preheating temperature at which a heater is preheated under general conditions.

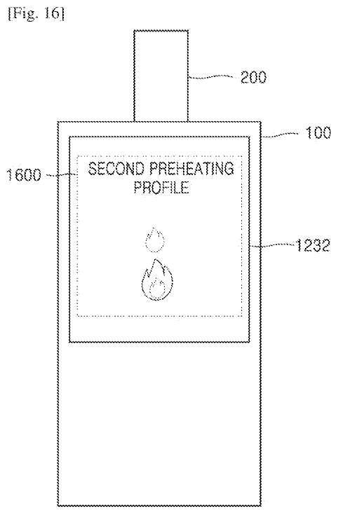

As shown in FIG. 15, the aerosol-generating apparatus 100 may display, on the display 1232, information 1500 indicating that the heater 1250 is preheated according to the first preheating profile. When the preheating of the heater according to the first preheating profile is completed (e.g., when the preheating time defined in the first preheating profile is reached), the aerosol-generating apparatus 100 may display, on the display 1232, information indicating the preheating has been completed, or output a notification, such as vibration, etc., through the haptic unit 1234.

In an embodiment, when the temperature of the heater is higher than or equal to the reference temperature, the aerosol-generating apparatus 100 loads a second preheating profile from the memory 1270 and supplies power to the heater 1250 according to the second preheating profile. The second preheating profile defines a preheating time and a preheating temperature at which the heater is preheated. For example, the initial temperature of the heater is high when the apparatus is continuously used. That is, when an aerosol-generating article 200 is inserted within a few seconds after the previous aerosol-generating article 200 is removed from the aerosol-generating article 200, the temperature of the heater 1250 may be higher than when the aerosol-generating article 200 is initially inserted, because of residual heat of the heater 1250 from the previous smoking. In this case, the aerosol-generating apparatus 100 loads, from the memory 1270, the second preheating profile different from the first preheating profile and supplies power to the heater 1250 according to the second preheating profile. Therefore, at the beginning of the second smoking series, heat due to the high temperature may be reduced and a sufficient amount of aerosol may be provided to the user.

As shown in FIG. 16, the aerosol-generating apparatus 100 may display, on the display 1232, information 1600 indicating that the heater 1250 is preheated according to the second preheating profile. When the preheating of the heater 1250 according to the second preheating profile is completed (e.g., when the preheating time defined in the second preheating profile is reached), the aerosol-generating apparatus 100 may display, on the display 1232, information indicating the preheating has been completed, or output a notification, such as vibration, etc., through the haptic unit 1234.

One embodiment may also be implemented in the form of a computer-readable recording medium including instructions executable by a computer, such as a program module executable by the computer. The computer-readable recording medium may be any available medium that can be accessed by a computer, including both volatile and nonvolatile media, and both removable and non-removable media. In addition, the computer-readable recording medium may include both a computer storage medium and a communication medium. The computer storage medium includes all of volatile and nonvolatile media, and removable and non-removable media implemented by any method or technology for storage of information such as computer-readable instructions, data structures, program modules, or other data. The communication medium typically includes computer-readable instructions, data structures, other data in modulated data signals such as program modules, or other transmission mechanisms, and includes any information transfer media.

The descriptions of the above-described embodiments are merely examples, and it will be understood by those of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

1. An aerosol-generating apparatus comprising:
a heater configured to heat at least a portion of an aerosol-generating article;
a temperature sensor configured to measure a temperature of the heater; and
a processor configured to control supply of power to the heater according to a first preheating profile that defines a preset preheating time and a preset preheating temperature,
wherein the processor is further configured to, when the temperature of the heater is higher than or equal to a reference temperature, control the supply of power to the heater according to a second preheating profile that is different from the first preheating profile.

2. The aerosol-generating apparatus of claim 1, wherein the processor is further configured to, when the temperature of the heater is higher than or equal to the reference temperature, determine that continued smoking is performed.

3. The aerosol-generating apparatus of claim 2, wherein the processor is further configured to, when insertion of the aerosol-generating article is detected, measure the temperature of the heater and determine whether the temperature of the heater is higher than or equal to the reference temperature.

4. The aerosol-generating apparatus of claim 1, wherein a temporal section during which a target temperature is reached is set to be shorter in the second preheating profile than in the first preheating profile.

5. The aerosol-generating apparatus of claim 1, wherein a temporal section during which a target temperature is maintained is set to be longer in the second preheating profile than in the first preheating profile.

6. The aerosol-generating apparatus of claim 1, wherein a temporal section during which the temperature of the heater decreases is set to be longer in the second preheating profile than in the first preheating profile.

7. The aerosol-generating apparatus of claim 1, wherein the processor is further configured to, when the temperature of the heater is higher than or equal to the reference temperature, control the supply of power to the heater according to the second preheating profile after a certain delay time has passed.

8. The aerosol-generating apparatus of claim 7, wherein the processor is further configured to differently determine a length of the delay time according to the temperature of the heater.

9. The aerosol-generating apparatus of claim 1, further comprising a display configured to display a preheating mode of the aerosol-generating apparatus,
wherein the processor is further configured to control the display to display the preheating mode according to the first preheating profile or the second preheating profile.

10. The aerosol-generating apparatus of claim 9, wherein the processor is further configured to, when the preheating time according to the first preheating profile or the second preheating profile is reached, control the display to output a notification indicating that the preheating is completed.

11. A method of controlling an aerosol-generating apparatus, the method comprising:
measuring a temperature of a heater configured to heat at least a portion of an aerosol-generating article;
determining whether the temperature of the heater is higher than or equal to a reference temperature; and
when the temperature of the heater is higher than or equal to the reference temperature, controlling supply of power to the heater according to a second preheating profile that is different from a first preheating profile.

12. The method of claim 11, wherein the determining comprises, when the temperature of the heater is higher than or equal to the reference temperature, determining that continued smoking is performed.

13. The method of claim 11, further comprising detecting insertion of the aerosol-generating article,
wherein, when the insertion of the aerosol-generating article is detected, the temperature of the heater is measured, and a determination as to whether the temperature of the heater is higher than or equal to the reference temperature is made.

14. The method of claim 11, wherein a temporal section during which the temperature of the heater increases to a target temperature is reached is set to be shorter in the second preheating profile than in a temporal section of the first preheating profile,
a temporal section during which the target temperature is maintained is set to be longer in the second preheating profile than in the first preheating profile, or
a temporal section during which the temperature of the heater decreases lower than the target temperature is set to be longer in the second preheating profile than in the first preheating profile.

15. The method of claim 11, wherein, when the temperature of the heater is higher than or equal to the reference temperature, the supply of power to the heater is controlled according to the second preheating profile after a certain delay time has passed.
